(19) United States
(12) Patent Application Publication
(10) Pub. No.: US 2015/0340690 A1
(43) Pub. Date: Nov. 26, 2015

(54) ENERGY STORAGE DEVICE

(71) Applicant: GS Yuasa International Ltd., Kyoto-shi (JP)

(72) Inventor: Takeshi Sasaki, Kyoto-shi (JP)

(21) Appl. No.: 14/716,675

(22) Filed: May 19, 2015

(30) Foreign Application Priority Data
May 22, 2014 (JP) 2014-106141

(51) Int. Cl. H01M 4/36; H01M 10/04

(52) U.S. Cl. CPC H01M 4/366; H01M 10/0431

(57) ABSTRACT

An energy storage device comprising: a sheet-like positive electrode and a sheet-like negative electrode, the positive electrode and the negative electrode being layered; wherein each of the electrodes includes a current collecting substrate and active material layers disposed on both surfaces of the current collecting substrate, at least a part of each of the current collecting substrates extends to an end portion of each of the electrodes and is bent toward one side in a layered direction at the end portion, and a bending direction of the current collecting substrate in the layered direction at the end portion of the positive electrode is opposite to a bending direction of the current collecting substrate in the layered direction at the end portion of the negative electrode which is adjacent to the end portion of the positive electrode.

### CROSS-REFERENCE TO RELATED APPLICATIONS

This application claims the benefit of Japanese patent application No. 2014-106141, filed on May 22, 2014, which is incorporated by reference.

### FIELD

The present invention relates to an energy storage device.

### BACKGROUND

Conventionally, various energy storage devices are known. For example, an energy storage device has been proposed in which a sheet-like positive electrode and a sheet-like negative electrode are provided as an electrode and the positive electrode and the negative electrode face each other.

In this type of energy storage device, for example, each of the positive electrode and the negative electrode are layered in a thickness direction. In addition, each of the electrodes includes, for example, a sheet-like current collecting substrate and active material layers which are disposed on both sides of the current collecting substrate, respectively.

An example of this type of energy storage device is disclosed in, for example, WO 2011/016243 A. The energy storage device disclosed in WO 2011/016243 A includes an electrode assembly which is formed by winding of the positive electrode and the negative electrode layered each other and a case which accommodates the electrode assembly therein.

Furthermore, in the energy storage device disclosed in WO 2011/016243 A, the negative electrode is formed in such a manner that a wide negative electrode plate (original negative electrode plate) disposed with active material layers on both sides of a sheet-like current collecting substrate is cut in the thickness direction. That is, at least a part of an end portion of the negative electrode has a bent end portion in which the current collecting substrate is bent by the cutting.

Since the bent end portion of the negative electrode is formed by the cutting of the wide negative electrode plate in the thickness direction, the end portion of the current collecting substrate at the bent end portion is bent toward one side in the thickness direction of the negative electrode while extending to an end edge of the negative electrode. That is, at the bent end portion of the negative electrode, the current collecting substrate is bent toward one of the active material layers of the negative electrode by cutting force during the cutting.

Moreover, in the energy storage device disclosed in WO 2011/016243 A, the electrode assembly is formed by the winding of the layered positive electrode and negative electrode. In the electrode assembly, the bending direction of the current collecting substrate at the bent end portion of the negative electrode is aligned in a winding center direction of the electrode assembly.

In such an energy storage device, the active material layers of the negative electrode expand due to the charge. By this expansion, the electrode assembly expands outward.

In such an energy storage device, the direction in which the current collecting substrate at the bent end portion of the negative electrode is bent while extending to the end edge of the negative electrode is the winding center direction of the electrode assembly. Accordingly, since the current collecting substrate is bent in the winding center direction of the electrode assembly, the end edge of the current collecting substrate hardly comes in contact with the inner surface of the case even when the electrode assembly expands outward. Thus, such an energy storage device suppresses, for example, the end edge of the current collecting substrate from coming in contact with the case by the expansion of the electrode assembly due to charge-discharge.

### SUMMARY

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

The energy storage device disclosed in WO 2011/016243 A includes the negative electrode having the bent end portion and is configured such that the bending direction of the current collecting substrate at the bent end portion is aligned in a predetermined direction. Accordingly, in case of this energy storage device, the non-uniform charge/discharge reaction may occur in the bent end portion during the charge-discharge.

Specifically, in this energy storage device, since the bent end portion of the negative electrode is formed by the cutting, the bent end portion of the negative electrode is subjected to the cutting force toward at least one side in the thickness direction at the cutting. Therefore, in this energy storage device, for example, as the density of the active material layer disposed on one surface of the current collecting substrate becomes higher due to the cutting force, the density of the active material layer disposed on the other surface of the current collecting substrate becomes lower. When the density difference occurs in each of the active material layers, the non-uniform charge/discharge reaction may occur during the charge-discharge. When this energy storage device is a lithium ion secondary battery, for example, lithium may be precipitated at the bent end portion of the negative electrode due to the non-uniform charge/discharge reaction.

An object of the present invention is to provide an energy storage device in which the non-uniform charge/discharge reaction is suppressed even though the current collecting substrate is bent at the end portion of the electrode.

An energy storage device according to an aspect of the present invention includes: a sheet-like positive electrode and a sheet-like negative electrode, the positive electrode and the negative electrode being layered, wherein each of the electrodes includes a current collecting substrate and active material layers disposed on both surfaces of the current collecting substrate, at least a part of each of the current collecting substrates extends to an end portion of each of the electrodes and is bent toward one side in a layered direction at the end portion, and a bending direction of the current collecting substrate in the layered direction at the end portion of the positive electrode is opposite to a bending direction of the current collecting substrate in the layered direction at the end portion of the negative electrode which is adjacent to the end portion of the positive electrode.

### BRIEF DESCRIPTION OF DRAWINGS

The foregoing and other features of the present invention will become apparent from the following description and drawings of an illustrative embodiment of the invention in which:

FIG. 1 is a cross-sectional view schematically illustrating an example of a cross-section of the line II-II of an electrode assembly illustrated in FIG. 3.

FIG. 2 is a cross-sectional view schematically illustrating another example of the cross-section of the line II-II of the electrode assembly illustrated in FIG. 3.

FIG. 3 is a schematic diagram schematically illustrating an example of a flat electrode assembly when viewed from one side.

FIG. 4 is a schematic diagram schematically illustrating an example of a layered structure of the electrode assembly.

FIG. 5 is a schematic diagram schematically illustrating an internal structure in an example of a nonaqueous electrolyte secondary battery (lithium ion secondary battery) as an energy storage device.

FIG. 6 is a schematic diagram schematically illustrating an example of a cross-section of an electrode assembly.

FIG. 7 is an exploded schematic diagram schematically illustrating a part of a structure in an example of a winding-type electrode assembly.

FIG. 8 is a schematic diagram schematically illustrating a cross-section of the line IV-IV of an electrode assembly illustrated in FIG. 9.

FIG. 9 is a diagram illustrating another example of an appearance of a nonaqueous electrolyte secondary battery (lithium ion secondary battery) as an energy storage device.

### DESCRIPTION OF EMBODIMENTS

An energy storage device according to an aspect of the present invention includes: a sheet-like positive electrode and a sheet-like negative electrode as an electrode, the positive electrode and the negative electrode being layered, wherein each of the electrodes includes a current collecting substrate and active material layers disposed on both surfaces of the current collecting substrate, at least a part of each of the current collecting substrates extends to an end portion of each of the electrodes and is bent toward one side in a layered direction at the end portion, and a bending direction of the current collecting substrate in the layered direction at the end portion of the positive electrode is opposite to a bending direction of the current collecting substrate in the layered direction at the end portion of the negative electrode which is adjacent to the end portion of the positive electrode.

In another aspect of the energy storage device, the end portions of the positive electrode and the negative electrode may be alternately arranged in the layered direction, and the end portions of the current collecting substrate of the positive electrode may be bent in the same direction in the layered direction, the end portions of the current collecting substrate of the negative electrode may be bent in an opposite direction to the end portions of the current collecting substrate of the positive electrode in the layered direction.

In still another aspect of the energy storage device, a thickness of the positive electrode and a thickness of the negative electrode may be constant.

In still another aspect of the energy storage device, at least one of the electrodes may be formed in a rectangular shape and the bending directions of the current collecting substrate may be the same at the end portions along at least two sides of the one rectangular electrode.

According to the aspects of the present invention, the energy storage device has an effect that the non-uniform charge/discharge reaction is suppressed even though the current collecting substrate is bent at the end portion of the electrode.

An energy storage device according to an embodiment of the present invention will be described below with reference to the drawings. An example of the energy storage device according to the embodiment includes a primary battery, a secondary battery, a capacitor, etc. In the present embodiment, a chargeable/dischargeable secondary battery will be described as an example of the energy storage device.

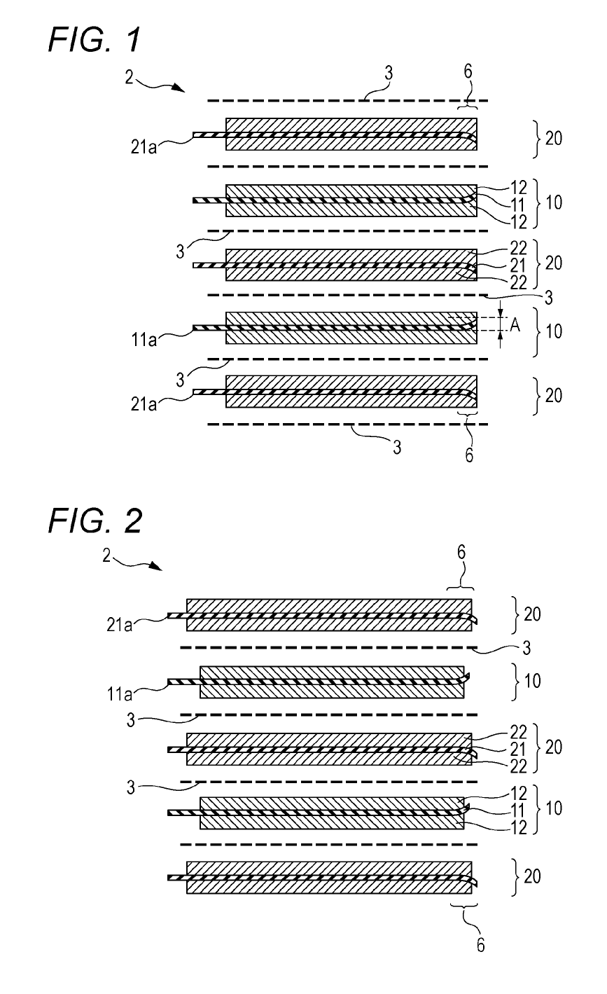

As illustrated in FIGS. 1 and 2, an energy storage device 1 according to the present embodiment includes: sheet-like positive electrodes 10 and sheet-like negative electrodes 20, the positive electrodes 10 and the negative electrodes 20 being layered, wherein the electrodes include current collecting substrates 11 and 21 and active material layers 12 and 22 disposed on both surfaces of the current collecting substrates 11 and 21, respectively, at least a part of each of the current collecting substrates 11 and 21 extends to an end portion of each of the electrodes and is bent toward one side in a layered direction at the end portion, and a bending direction of the current collecting substrate 11 in the layered direction at the end portion of the positive electrode 10 is opposite to a bending direction of the current collecting substrate 21 in the layered direction at the end portion of the negative electrode 20 which is adjacent to the end portion of the positive electrode 10.

Specifically, according to the energy storage device 1 of the present embodiment, positive electrode current collecting substrates 11 as the current collecting substrate are bent in the same direction and negative electrode current collecting substrates 21 as the current collecting substrate are bent in an opposite direction to the positive electrode current collecting substrates 11 at the end portions of the positive electrodes 10 and the negative electrodes 20 which are alternately arranged in the layered direction.

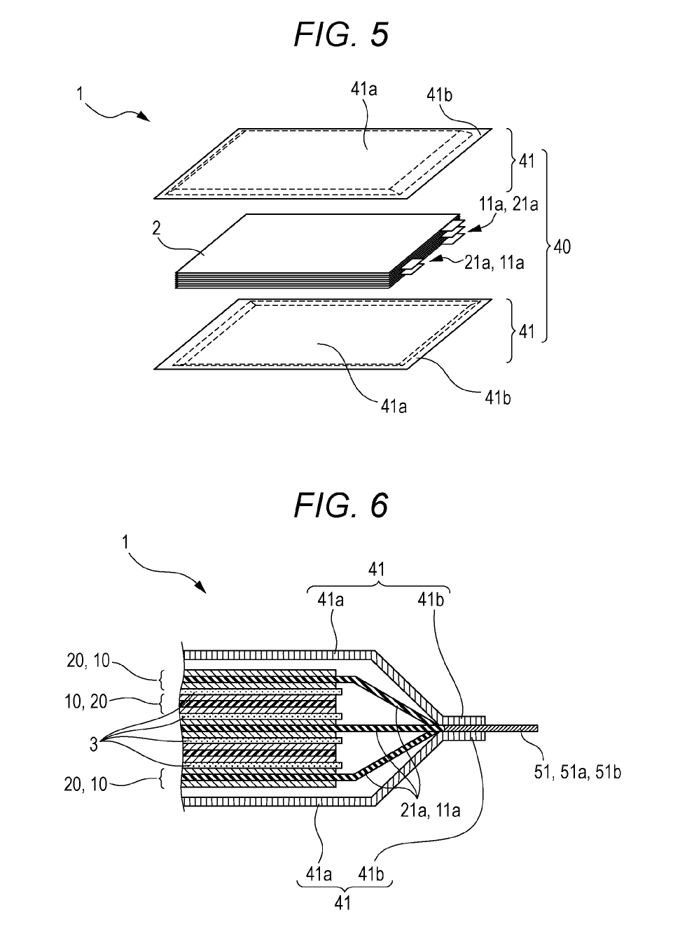

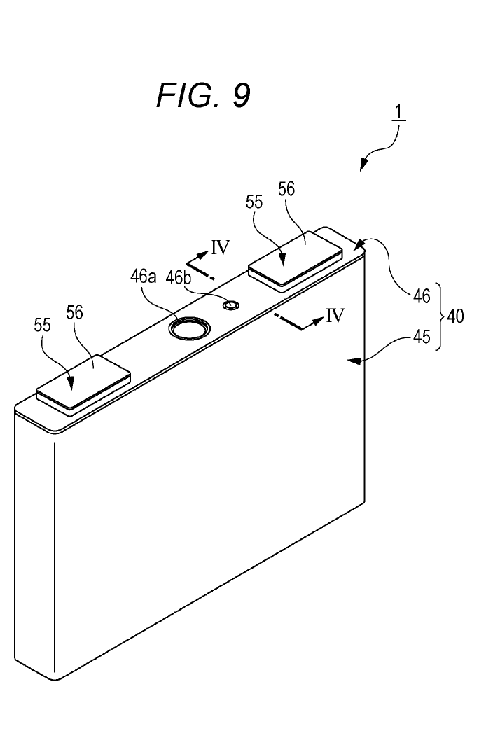

The energy storage device according to the present embodiment is a nonaqueous electrolyte secondary battery. Specifically, an example of the energy storage device 1 according to the present embodiment may include a nonaqueous electrolyte secondary battery 1 (lithium ion secondary battery) illustrated in FIGS. 5 and 9.

This type of energy storage device supplies electric energy. The energy storage device is used in single or multiple forms. Specifically, the energy storage device is used in a single form when a required output and a required voltage are small. Meanwhile, the energy storage device is used in an energy storage apparatus in combination with other energy storage devices when at least one of the required output and the required voltage is large. In the energy storage apparatus, the energy storage device to be used in the energy storage apparatus supplies electric energy.

### First Embodiment

The energy storage device 1 according to a first embodiment includes, for example, an electrode assembly 2 in which a plurality of positive electrodes 10 and a plurality of negative electrodes 20 are layered.

Moreover, for example, as illustrated in FIG. 5, the energy storage device 1 according to the first embodiment includes a case 40 that accommodates the electrode assembly 2 therein.

In addition, the energy storage device 1 according to the first embodiment includes an electrolyte solution stored in the case 40.

The energy storage device 1 according to the first embodiment includes a plurality of sheet-like separators 3.

As illustrated in FIGS. 1 and 2, the separator 3 is disposed between the positive electrode 10 and the negative electrode 20. As illustrated in FIG. 1, each of the separators 3 may be disposed at the outermost side in a layered direction of the electrode assembly 2. Meanwhile, as illustrated in FIG. 2, the separator 3 may not be disposed at the outermost side in the layered direction of the electrode assembly 2.

The electrode assembly 2 is typically formed in a flat shape (plate shape).

As illustrated in FIGS. 4 and 5, the electrode assembly 2 includes the plurality of positive electrodes 10 and the plurality of negative electrodes 20 and is formed in such a manner that the positive electrodes 10 and the negative electrodes 20 are alternately layered in a thickness direction.

As will be described below, for example, the electrode assembly 2 may be formed in such a manner that the band-like positive electrode 10 and the band-like negative electrode 20 are overlapped with each other and are further wound.

Specifically, for example, as illustrated in FIGS. 1 and 2, the electrode assembly 2 includes the sheet-like positive electrodes 10 and the sheet-like negative electrodes 20 as an electrode. At least one of the positive electrode 10 and the negative electrode 20 is formed in a rectangular shape.

Each of the electrodes includes a sheet-like current collecting substrate and active material layers containing an active material and disposed respectively on both sides of the current collecting substrate.

That is, the positive electrode 10 includes a sheet-like positive electrode current collecting substrate 11 and positive active material layers 12 disposed respectively on both sides of the positive electrode current collecting substrate 11, the positive active material layer containing a positive active material.

Similarly, the negative electrode 20 includes a sheet-like negative electrode current collecting substrate 21 and negative active material layers 22 disposed respectively on both sides of the negative electrode current collecting substrate 21, the negative active material layer containing a negative active material.

For example, the current collecting substrates are bent at end portions along at least two sides of each rectangular electrode, and the current collecting substrates have the same bending direction at the end portions at which the current collecting substrates are bent.

Specifically, at least a part of the end portion of each of the positive electrode 10 and the negative electrode 20 as the electrode has a bent end portion 6 at which the current collecting substrate is bent by cutting in the thickness direction.

At the bent end portion 6, the active material layers 12 and 22 are disposed on both sides of the current collecting substrates 11 and 21, respectively. In addition, the current collecting substrates 11 and 21 extend toward end edges of the electrodes (positive electrode 10 and negative electrode 20) and are simultaneously bent toward one surface of the electrodes, respectively.

For example, as illustrated in FIGS. 1 and 2, the bent end portion 6 of the positive electrode 10 is disposed to be adjacent to the bent end portion 6 of the negative electrode 20 in the thickness direction (layered direction).

Moreover, at the bent end portion 6 of the positive electrode 10 and the bent end portion 6 of the negative electrode 20 adjacent to each other, the current collecting substrates 11 and 12 have the bending directions bent toward one surface of the electrodes (positive electrode 10 and negative electrode 20) to be opposite to each other in the thickness direction, respectively.

In the energy storage device 1 according to the first embodiment, each of the positive electrode 10 and the negative electrode 20 has the bent end portion 6 at which the current collecting substrate is bent by the cutting in the thickness direction. Accordingly, as the density of one active material layer at each of the bent end portions 6 becomes higher by the cutting, the density of the other active material layer becomes lower. That is, at the bent end portion 6 of each of the positive electrode 10 and the negative electrode 20, as the density of the active material layer disposed on one surface of the current collecting substrate becomes higher by the cutting, the density of the active material layer disposed on the other surface becomes lower. Furthermore, at the bent end portion 6, the current collecting substrate is bent toward the electrode surface of the active material layer side having the high density.

However, the bent end portion 6 of the positive electrode 10 and the bent end portion 6 of the negative electrode 20 are adjacent to each other, and at the bent end portions 6 of both electrodes, the current collecting substrates have the bending directions bent toward one surface of the electrodes to be opposite to each other in the thickness direction, respectively. That is, at the bent end portion 6 of the positive electrode 10 and the bent end portion 6 of the negative electrode 20 adjacent to each other, the active material layers having the high density are adjacent to each other or the active material layers having the low density are adjacent to each other.

Accordingly, since the active material layers having the high density are adjacent to each other or the active material layers having the low density are adjacent to each other, charge/discharge reaction becomes more uniform between the active material layers facing each other at the bent end portion 6 of the positive electrode 10 and the bent end portion 6 of the negative electrode 20.

Therefore, in the energy storage device 1, the non-uniform charge/discharge reaction is suppressed even though the current collecting substrate is bent at the end portion of the electrode. That is, in the energy storage device 1 described above, the non-uniform charge/discharge reaction is suppressed even though the current collecting substrate is bent by the cutting and the electrode including the active material layers having high density difference on both sides of the current collecting substrate is provided.

For example, as illustrated in FIGS. 1 and 2, the positive electrode 10 includes the sheet-like positive electrode current collecting substrate 11 and the positive active material layers 12 containing a particulate positive active material. The positive active material layers 12 are disposed on both surfaces of the positive electrode current collecting substrate 11.

For example, as illustrated in FIG. 4, the positive electrode 10 has a rectangular sheet shape.

The thickness of the positive electrode 10 is typically 35 to 250 μm. In addition, the thickness of the positive electrode current collecting substrate 11 is typically 5 to 50 μm, and the thickness of the positive active material layer 12 is typically 15 to 100 μm.

The thickness of the positive electrode 10 is typically constant.

The negative electrode 20 includes the sheet-like negative electrode current collecting substrate 21 and the negative active material layer 22 disposed on both surfaces of the negative electrode current collecting substrate 21 and containing a particulate negative active material.

For example, as illustrated in FIG. 4, the negative electrode 20 has a rectangular sheet shape.

The thickness of the negative electrode 20 is typically 35 to 250 μm. In addition, the thickness of the negative electrode current collecting substrate 21 is typically 5 to 50 μm, and the thickness of the negative active material layer 22 is typically 15 to 100 μm.

The thickness of the negative electrode 20 is typically constant.

For example, in the electrode assembly 2, as illustrated in FIGS. 1 and 2, the positive electrode 10 and the negative electrode 20 are overlapped with each other with the separator 3 interposed therebetween such that the positive active material layer 12 and the negative active material layer 22 face each other in the thickness direction.

Furthermore, in the electrode assembly 2, for example, as illustrated in FIG. 4, the plurality of positive electrodes 10 and the plurality of negative electrodes 20 are layered in the thickness direction and the positive electrodes 10 and the negative electrodes 20 are alternately arranged in the layered direction. In addition, the positive active material layer 12 of the positive electrode 10 faces the negative active material layer 22 of the negative electrode 20 through the separator 3.

At least a part of the end portion of each of the electrodes (positive electrode 10 and negative electrode 20) has the bent end portion 6 formed by being cut in the thickness direction.

The bent end portion 6 is formed in such a manner that a wide electrode plate including a pre-cutting current collecting substrate and pre-cutting active material layers respectively disposed on both surfaces of the pre-cutting current collecting substrate is cut in the thickness direction. The wide electrode plate will be described below in detail.

Since the bent end portion 6 is formed in such a manner that the wide electrode plate is cut in the thickness direction, the current collecting substrate is bent toward one active material layer (one side of the electrode in the thickness direction) of the electrode while extending to the end edge of the electrode at the bent end portion 6. For example, as illustrated in FIGS. 1 and 2, at the bent end portion 6, the current collecting substrate extends toward the end edge of the electrode. The active material layers are disposed on both surfaces of the current collecting substrate at the bent end portion 6, respectively.

For example, the bent end portion 6 of one electrode is formed in such a manner that the current collecting substrate approaches the surface of the other electrode as the current collecting substrate approaches the end edge of the electrode.

The bent end portion 6 represents a part of the end portion of each electrode from a site where the current collecting substrate extending toward the end edge of the electrode starts to approach one surface of the electrode to the end edge of the electrode.

The bent end portion 6 is formed in such a manner that the wide electrode plate is cut by cutting force applied from at least one side in the thickness direction toward the other side. Accordingly, at the bent end portion 6, as the density of one active material layer becomes higher by the cutting force, the density of the other active material layer becomes lower. That is, at the bent end portion 6 of each electrode, the density of the active material layer disposed on one surface of the current collecting substrate becomes higher and the density of the active material layer disposed on the other surface becomes lower.

In the electrode assembly 2, the bent end portion 6 of the positive electrode 10 and the bent end portion 6 of the negative electrode 20 are disposed to be adjacent to each other in the layered direction (thickness direction) through the separator 3.

For example, as illustrated in FIGS. 1 and 2, the expression of “the bent end portions 6 of the respective electrodes are adjacent to each other” means that at least a part of one bent end portion 6 faces at least a part of the other bent end portion 6. That is, this means that at least a part of one bent end portion 6 is overlapped with at least a part of the other bent end portion 6 when the respective bent end portions 6 are viewed from one side in the thickness direction (layered direction) of the electrode to the other side.

In the electrode assembly 2, at the bent end portion 6 of the positive electrode 10 and at the bent end portion 6 of the negative electrode 20 adjacent to each other, the current collecting substrates have the bending directions bent toward one active material layer while extending to the end edge of the positive electrode 10 or the end edge of the negative electrode 20 to be opposite to each other in the thickness direction. That is, the bending direction of the positive electrode current collecting substrate 11 at the bent end portion 6 of the positive electrode 10 is opposite to the bending direction of the negative electrode current collecting substrate 21 at the bent end portion 6 of the negative electrode 20 which is adjacent to the bent end portion 6 of the positive electrode 10.

Since the electrode assembly 2 is configured as described above, the positive active material layer 12 and the negative active material layer 22 in which the densities become higher due to the cutting force are adjacent to each other or the positive active material layer 12 and the negative active material layer 22 in which the densities become lower are adjacent to each other, at the adjacent bent end portions 6.

Accordingly, as the active material layers having the high density are adjacent to each other or as the active material layers having the low density are adjacent to each other, the charge/discharge reaction between the positive active material layer 12 and the negative active material layer 22 becomes more uniform between the bent end portion 6 of the positive electrode 10 and the bent end portion 6 of the negative electrode 20 which are adjacent to each other.

As illustrated in FIGS. 1 and 2, in the electrode assembly 2, the positive electrodes 10 and the negative electrodes 20 are alternately arranged in the layered direction. Specifically, the bent end portions 6 of the positive electrodes 10 are arranged in the layered direction and the bent end portions 6 of the negative electrodes 20 are arranged in the layered direction. The bending directions of the current collecting substrates are the same at the bent end portions 6 of the plurality of positive electrodes 10 arranged in the layered direction, respectively. In addition, the bending directions of the current collecting substrates are the same at the bent end portions 6 of the plurality of negative electrodes 20 arranged in the layered direction, respectively.

For example, as illustrated in FIG. 1, the bent end portion 6 is formed such that the end edge of the current collecting substrate and the end edge of each active material layer have the same plane. Alternatively, for example, as illustrated in FIG. 2, the bent end portion 6 may be formed such that the end edge of the current collecting substrate protrudes outward more than the end edge of the active material layer.

The bent end portion 6 is formed on at least a part of the end portion of each of the electrodes (positive electrode 10 and negative electrode 20). Preferably, at least one of the electrodes is formed in a rectangular shape and the bent end portion 6 is formed at an end portion along at least two sides of the rectangular electrode.

Specifically, for example, the bent end portions 6 are formed along three sides of the rectangular electrode. A current collecting tab to be described below is an end portion at which the bent end portion 6 is not formed and may be disposed at a part of an end portion along the remaining one side of the electrode.

The bent end portions 6 may be formed at all of the end portions of each of the electrodes (positive electrode 10 and negative electrode 20). Specifically, for example, the bent end portions 6 may be formed by punching of the wide electrode plate at all of the end portions. By the punching of the wide electrode plate, the current collecting tab protruding outward more than the separator 3 can be formed.

When the electrode assembly 2 is a winding type to be described below, the bent end portion 6 is typically formed along two facing sides of the rectangular electrode. In this case, the electrode assembly 2 is configured such that each of the bent end portions 6 is disposed along a winding direction at both sides of the winding axis.

The current collecting substrates 11 and 21 are typically bent in the same direction at the bent end portions 6 of the electrodes, respectively. For example, the current collecting substrates 11 and 21 are bent in the same direction at the bent end portions 6 formed along at least two sides of the rectangular electrodes, respectively.

At the bent end portion 6, the current collecting substrates 11 and 21 typically have a bent width (length “A” illustrated in FIG. 1) which exceeds 0 μm and 100 μm or less. The bent width represents the maximum width (length in thickness direction) of the current collecting substrate at the bent end portion 6.

When the electrode assembly 2 is viewed from one side in the layered direction, for example, an area of the negative active material layer 22 is larger than that of the positive active material layer 12. Moreover, the positive active material layer 12 is disposed inside the negative active material layer 22.

With such a configuration, it is possible to certainly insert Li-ions, which are moved toward the negative electrode 20 from the positive active material layer 12 during the charge, onto the negative active material layer 22.

The positive electrode current collecting substrate 11 is typically formed in a rectangular sheet shape. A part of the end portion of the positive electrode current collecting substrate 11 may protrude outward to form a current collecting tab 11a.

The thickness of the positive electrode current collecting substrate 11 is not particularly limited, but is typically 1 to 500 μm.

Examples of materials of the positive electrode current collecting substrate 11 may include metals such as aluminum, titanium, stainless steel, and nickel.

Examples of the materials of the positive electrode current collecting substrate 11 may include baked carbon, conductive polymers etc. in addition to the metals.

Example of the positive electrode current collecting substrate 11 may include metal foils.

The shape of the positive active material layer 12 is, for example, a rectangular shape when viewed from one surface side.

The positive active material includes a metal compound that can contribute to an electrode reaction of a charge reaction and a discharge reaction in the positive electrode 10.

The positive active material is typically formed into particles.

The metal compound included in the positive active material is not particularly limited, but may be, for example, lithium composite oxides such as lithium nickelate (LiNiO₂), spinel lithium manganate (LiMn₂O₄), and lithium cobaltate (LiCoO₂).

In addition, examples of the metal compound may include olivine-type lithium metal phosphate such as lithium iron phosphate.

If necessary, the positive active material layer 12 contains a conductive agent, a binder, a thickener, a filler, etc. as a component.

Examples of the conductive agent include, but are not particularly limited to, natural graphite (scale-like graphite, flaky graphite, earthy graphite or the like), artificial graphite, carbon black, acetylene black, ketjen black, carbon whisker, carbon fibers, metal (copper, nickel, aluminum, silver, gold or the like) powders, metal fibers, and conductive ceramics.

For example, as the conductive agent, a single substance or a mixture of two or more thereof is employed.

Examples of the binder include, but are not particularly limited to, thermoplastic resins such as polytetrafluoroethylene (PTFE), polyvinylidene fluoride (PVDF), polyethylene, and polypropylene, ethylene-propylene-diene terpolymer (EPDM), sulfonated EPDM, styrene-butadiene rubber (SBR), and fluorine rubber.

For example, as the binder, a single substance or a mixture of two or more thereof is employed.

Examples of the thickener include, but are not particularly limited to, polysaccharides such as carboxymethylcellulose and methylcellulose.

For example, as the thickener, a single substance or a mixture of two or more thereof is employed.

Examples of the filler include, but are not particularly limited to, olefin-based polymers such as polypropylene and polyethylene, amorphous silica, alumina, zeolite, and glass.

The negative electrode current collecting substrate 21 is typically formed in a rectangular sheet shape. A part of the end portion of the negative electrode current collecting substrate 21 may protrude outward to form a current collecting tab 21a.

The thickness of the negative electrode current collecting substrate 21 is not particularly limited, but is typically 5 to 50 μm.

Examples of materials of the negative electrode current collecting substrate 21 may include metals such as copper, nickel, iron, stainless steel, titanium, and aluminum.

Examples of the materials of the negative electrode current collecting substrate 21 may include baked carbon, conductive polymers, conductive glass etc. in addition to the metals.

An example of the negative electrode current collecting substrate 21 may include metal foils of the metals described above.

The shape of the negative active material layer 22 is, for example, a rectangular shape when viewed from one side.

The negative active material is a substance that can contribute to an electrode reaction of a charge reaction and a discharge reaction in the negative electrode 20.

An example of the negative active material may include at least one of carbonaceous materials, lithium metal, alloys capable of insertion and extraction of lithium ion (lithium alloy and the like), metal oxides represented by a general formula MOz (“M” represents at least one element selected from W, Mo, Si, Cu, and Sn, and “z” represents a numerical value in the range of 0<z≦2), lithium metal oxides (Li₄Ti₅O₁₂ and the like), and polyphosphoric acid compounds.

An example of the carbonaceous material may include at least one of graphite and amorphous carbon.

Examples of the amorphous carbon may include hardly-graphitizable carbon (hard carbon), easily-graphitizable carbon (soft carbon) etc.

Examples of the alloy capable of insertion and extraction of lithium-ions may include wood alloy, at least one lithium alloy of lithium-aluminum alloy, lithium-lead alloy, lithium-tin alloy, lithium-aluminum-tin alloy, and lithium-gallium alloy, etc.

Similarly to the positive active material layer 12, the negative active material layer 22 contains the binder, thickener, filler, and the like as a component, if necessary.

The separator 3 prevents a short circuit between the electrodes while ensuring charge/discharge reaction between the electrodes.

The separator 3 is disposed between the positive active material layer 12 of the positive electrode 10 and the negative active material layer 22 of the negative electrode 20.

The separator 3 is made of, for example, a porous film or a nonwoven fabric. For example, the separator 3 is made of a single material of the porous film or the nonwoven fabric or a mixture thereof.

Examples of materials of the separator 3 may include at least one of polyolefin-based resins such as polyethylene and polypropylene, polyester-based resins such as polyethylene terephthalate and polybutylene terephthalate, and fluorine-based resins, etc.

The electrolyte solution is accommodated in the case 40. The electrode assembly 2 accommodated in the case 40 is impregnated with at least a part of the electrolyte solution.

The electrolyte solution typically contains a nonaqueous solvent and an electrolyte salt.

In general, the electrolyte solution contains the electrolyte salt at a concentration of 0.5 to 2.0 mol/L.

The nonaqueous solvent to be generally used in the energy storage device or the like is employed.

Specifically, examples of the nonaqueous solvent may include cyclic carbonate esters, lactones, chain carbonates, chain esters, ethers, nitriles, etc.

Examples of the cyclic carbonate esters may include propylene carbonate, ethylene carbonate, butylenes carbonate, chloroethylene carbonate, etc.

Examples of the lactones may include γ-butyrolactone, γ-valerolactone, etc.

Examples of the chain carbonates may include dimethyl carbonate, diethyl carbonate, ethyl methyl carbonate, etc.

Examples of the chain esters may include methyl formate, methyl acetate, methyl butyrate, etc.

Examples of the ethers may include 1,3-dioxane, 1,4-dioxane, 1,2-dimethoxyethane, 1,4-dibutoxyethane, methyl diglyme, etc.

Examples of the nitriles may include acetonitrile, benzonitrile, etc.

Moreover, examples of the nonaqueous solvent may include tetrahydrofuran and derivatives thereof, dioxolane and derivatives thereof, ethylenesulfide, sulfolane, sultone and derivatives thereof, etc.

As the nonaqueous solvent, the single substance or the mixture of two or more thereof described above is employed, but is not limited thereto.

Examples of the electrolyte salt may include lithium salts such as LiPF₆, LiClO₄, LiBF₄, LiAsF₆, LiCF₃SO₃, LiN(SO₂CF₃)₂, LiN(SO₂C₂F₅)₂, LiN(SO₂CF₃)(SO₂C₄F₉), LiSCN, LiBr, LiI, Li₂SO₄, and Li₂B₁₀Cl₁₀.

As the electrolyte salt, the single substance or the mixture of two or more thereof described above is employed, but is not limited thereto.

As illustrated in FIGS. 5 and 6, the nonaqueous electrolyte secondary battery 1 further includes the case 40 accommodating the electrode assembly 2 and a terminal serving as an electrical path with the outside of the battery during the charge-discharge. As the terminal, for example, a plate-shaped flat terminal 51 is used.

As illustrated in FIG. 5, the case 40 has a pair of case pieces 41.

Each of the case pieces 41 is opened in one direction and includes an accommodation portion 41a accommodating the electrode assembly 2 and a flange portion 41b extending outward from an opening edge of the accommodation portion 41a.

The case 40 is configured to accommodate the electrode assembly 2 and the electrolyte solution in an internal space between two accommodation portions 41a formed after surfaces of the flange portions 41b of the case pieces 41 are joined to each other while the openings of the accommodation portion 41a of the case pieces 41 face each other.

Each of the case pieces 41 is formed of, for example, a laminate material in which an aluminum foil and a resin film are layered.

For example, as described above, the electrode assembly 2 is accommodated in the case 40. The electrode assembly 2 is formed in such a manner that the plurality of positive electrodes 10 and the plurality of negative electrodes 20 are layered to be alternately arranged in the thickness direction.

The electrode assembly 2 is surrounded by the case 40 from the outside and is accommodated in the case 40 when the pair of case pieces 41 are joined to each other as described above.

As the flat terminal 51, a flat terminal 51a for the positive electrode and a flat terminal 51b for the negative electrode are used.

The flat terminal 51a for the positive electrode is connected to the current collecting tab 11a of each positive electrode current collecting substrate 11 in the electrode assembly 2 by, for example, a welding treatment. The outer portions of the current collecting tabs 11a are bundled by overlapping with each other and are connected to the flat terminal 51a.

Similarly, the flat terminal 51b for the negative electrode is connected to the current collecting tab 21a of each negative electrode current collecting substrate 21 in the electrode assembly 2 by, for example, a welding treatment. The outer portions of the current collecting tabs 21a are bundled by overlapping with each other and are connected to the flat terminal 51b.

A part of the flat terminal 51 is disposed outside the case 40 so as to be electrically connected to another energy storage device or an external device.

For example, the energy storage device 1 according to the first embodiment is provided with the electrode assembly 2 formed in such a manner that the plurality of positive electrodes 10 and the plurality of negative electrodes 20 are alternately layered multiple times in the thickness direction as described above, but the energy storage device 1 (hereinafter, also referred to as an energy storage device according to a second embodiment) according to the embodiment of the invention may be provided with the electrode assembly 2 (hereinafter, also referred to as a winding-type electrode assembly) formed in such a manner that one band-like positive electrode 10 and one band-like negative electrode 20 are overlapped with each other and are further wound.

### Second Embodiment

Similarly to the energy storage device 1 according to the first embodiment, the energy storage device 1 according to a second embodiment includes the sheet-like positive electrode 10 and the negative electrode 20 as an electrode.

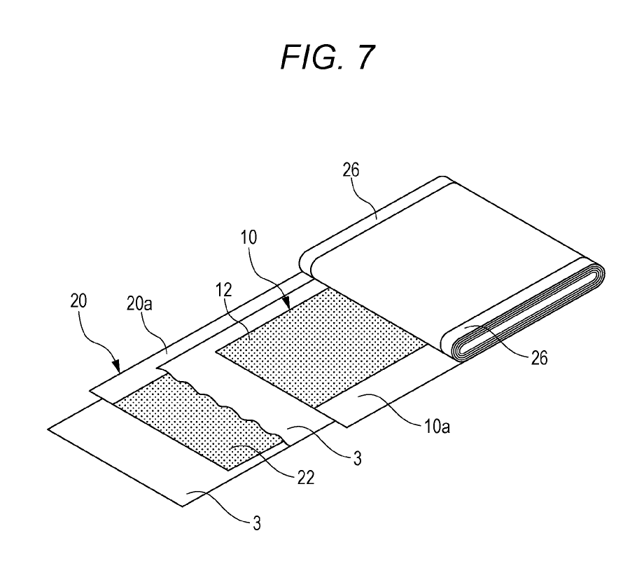

As illustrated in FIGS. 7 to 9, in the energy storage device 1 according to the second embodiment, one positive electrode 10 and one negative electrode 20 are layered and are further wound, thereby forming an electrode assembly 2 (winding-type electrode assembly).

In the winding-type electrode assembly 2, at least a part of an end portion has a structure illustrated in FIG. 1 or 2.

For example, as illustrated in FIG. 7, the winding-type electrode assembly 2 has a flat rectangular plate shape in a state of being wound.

In the winding-type electrode assembly 2, the bent end portions 6 are formed along two facing sides of each of the rectangular electrode. Specifically, the bent end portions 6 are formed at both end portions in a longitudinal direction of the band-like electrode, and the bent end portions 6 disposed at both end sides in the longitudinal direction of the band-like positive electrode 10 and the bent end portions 6 disposed at both end sides in the longitudinal direction of the band-like negative electrode 20 are alternately arranged in the layered direction.

Similarly to the energy storage device 1 according to the first embodiment, in the energy storage device 1 according to the second embodiment, the non-uniform charge/discharge reaction is suppressed even though the current collecting substrate is bent at the end portion of the electrode. That is, in the energy storage device 1 according to the second embodiment, the non-uniform charge/discharge reaction is suppressed even though the current collecting substrate is bent by cutting and the electrode including active material layers having high density difference on both sides of the current collecting substrate is provided.

The energy storage device 1 according to the second embodiment has the same configuration as that in the first embodiment unless otherwise specified.

As illustrated in FIGS. 7 to 9, the energy storage device 1 (energy storage device 1 provided with the winding-type electrode assembly 2) according to the second embodiment includes the winding-type electrode assembly 2, the case 40 accommodating the electrode assembly 2, and external terminals 55 which are terminals disposed outside the case 40 and are electrically connected with the electrode assembly 2. In addition, the energy storage device 1 includes a current collector 5, etc. through which the electrode assembly 2 and the external terminal 55 are electrically connected with each other, in addition to the electrode assembly 2, the case 40, and the external terminal 55.

As illustrated in FIG. 7, the positive electrode 10 of the winding-type electrode assembly 2 includes a non-covered portion 10a (a portion where the positive electrode current collecting substrate 11 is exposed), which is not covered with the positive active material layer 12, at one end edge in a width direction which is a transverse direction of the band shape.

The negative electrode 20 of the winding-type electrode assembly 2 includes a non-covered portion 20a (a portion where the negative electrode current collecting substrate 21 is exposed), which is not covered with the negative active material layer 22, at the other end edge (a side opposite to the non-covered portion of the positive electrode) in a width direction which is a transverse direction of the band shape. The width of the negative active material layer 22 is wider than that of the positive active material layer 12.

As illustrated in FIG. 7, in the winding-type electrode assembly 2, the positive electrode 10 and the negative electrode 20 are wound in a state of being insulated by the separator 3. The positive electrode 10 and the negative electrode 20 are insulated from each other by the separator 3, which is a member having an insulating property, in the electrode assembly 2. In addition, the separator 3 holds an electrolyte solution in the case 40. Thus, lithium-ions move between the positive electrode 10 and the negative electrode 20 which are alternately layered with the separator 3 held therebetween, during the charge-discharge of the energy storage device 1.

The width (dimension in the transverse direction of the band shape) of the separator 3 is slightly wider than that of the negative active material layer 22. The positive electrode 10 and the negative electrode 20 are overlapped with each other in a state where positions deviate from each other in the width direction, and the separator 3 is disposed between the positive electrode 10 and the negative electrode 20. The non-covered portion 10a of the positive electrode 10 is not overlapped with the non-covered portion 20a of the negative electrode 20. That is, the non-covered portion 10a of the positive electrode 10 protrudes from a region, where the positive electrode 10 and the negative electrode 20 are overlapped with each other, in the width direction, and the non-covered portion 20a of the negative electrode 20 protrudes from the region, where the positive electrode 10 and the negative electrode 20 are overlapped with each other, in the width direction (direction opposite to a protruding direction of the non-covered portion of the positive electrode). The layered positive electrode 10, negative electrode 20, and separator 3 are wound, thereby forming the electrode assembly 2.

A non-covered-layered portion 26 of the electrode assembly 2 is formed by a portion where the non-covered portion 10a of the positive electrode 10 is layered, and a non-covered-layered portion 26 of the electrode assembly 2 is formed by a portion where the non-covered portion 20a of the negative electrode 20 is layered.

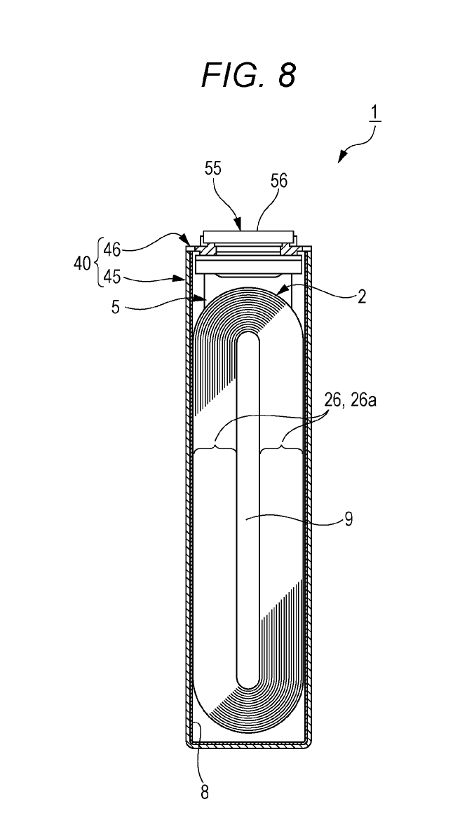

The non-covered-layered portion 26 is a portion which is electrically connected with the current collector 5. The non-covered-layered portion 26 is divided into two portions (non-covered-layered portions 26a and 26a divided into two parts) with, for example, a hollow portion 9 (see FIG. 8) held therebetween when viewed in a winding center direction of the wound positive electrode 10, negative electrode 20, and separator 3.

The non-covered-layered portion 26 described above is provided on each of the electrodes of the electrode assembly 2. That is, the non-covered-layered portion 26 layered with only the non-covered portion 10a of the positive electrode 10 constitutes the non-covered-layered portion of the positive electrode 10 in the electrode assembly 2, and the non-covered-layered portion 26 layered with only the non-covered portion 20a of the negative electrode 20 constitutes the non-covered-layered portion of the negative electrode 20 in the electrode assembly 2.

The case 40 includes a case body 45 having an opening and a cover plate 46 which blocks (closes) the opening of the case body 45. The case 40 accommodates an electrolyte solution other than the electrode assembly 2, the current collector 5, etc. in an internal space thereof. The case 40 is formed of a metal having resistance to the electrolyte solution. The case 40 is formed of, for example, an aluminum-based metal material such as aluminum or aluminum alloy. The case 40 may be formed of a metal material such as stainless steel or nickel, a composite material in which a resin such as nylon is adhered to aluminum, etc.

The case 40 is formed in such a manner that an opening periphery of the case body 45 and a periphery of the cover plate 46 are joined in a state of being overlapped with each other. In addition, the case 40 has an internal space defined by the case body 45 and the cover plate 46. The opening periphery of the case body 45 and the periphery of the cover plate 46 are joined to each other by, for example, welding.

The cover plate 46 is a plate-like member for blocking the opening of the case body 45. Specifically, the case 40 is configured as follows: the periphery of the cover plate 46 is overlapped with the opening periphery of the case body 45 such that the cover plate 46 blocks the opening of the case body 45 and the boundary between the cover plate 46 and the case body 45 is welded in the state where the opening periphery and the cover plate 46 are overlapped with each other.

The cover plate 46 has a contour corresponding to the opening periphery of the case body 45. That is, the cover plate 46 is a rectangular member. In addition, four corners of the cover plate 46 have a circular arc shape.

The cover plate 46 has a gas exhaust valve 46a capable of exhausting gas in the case 40 to the outside. The gas exhaust valve 46a is configured to exhaust the gas to the outside from the inside of the case 40 when the internal pressure of the case 40 rises to a predetermined pressure. The gas exhaust valve 46a is provided at the center of the cover plate 46.

The cover plate 46 is provided with a liquid injection hole for injecting the electrolyte solution. The liquid injection hole penetrates the cover plate 46 in the thickness direction.

The cover plate 46 is provided with a liquid injection plug 46b for sealing (blocking) the liquid injection hole. The liquid injection plug 46b is fixed to the case 40 (cover plate 46) by welding.

The external terminal 55 is a portion which electrically connected to an external terminal of another energy storage device or an external device. The external terminal 55 is formed by a member having conductivity. For example, the external terminal 55 is formed of a metal material having high weldability, for example, an aluminum-based metal material such as aluminum or aluminum alloy or a copper-based metal material such as copper or copper alloy.

The external terminal 55 has a bus-bar weldable surface 56. Such a surface 56 has a plane shape.

The current collector 5 is disposed in the case 40 and is directly or indirectly connected to the electrode assembly 2 in an electrically-conductive state. The current collector 5 is connected to the electrode assembly 2 through a clip member in an electrically-conductive state. That is, the energy storage device 1 includes the clip member which connects the electrode assembly 2 and the current collector 5 to each other in an electrically-conductive state.

The current collector 5 is formed by a conductive member. The current collector 5 is disposed along an inner surface of the case 40.

The current collector 5 is each connected to the positive electrode 10 and the negative electrode 20 of the energy storage device 1. In the energy storage device 1 of this embodiment, the current collector 5 is disposed in the case 40 so as to be each connected to the non-covered-layered portion 26 of the positive electrode 10 and the non-covered-layered portion 26 of the negative electrode 20 in the electrode assembly 2.

The current collector 5 connected to the positive electrode 10 and the current collector 5 connected to the negative electrode 20 are formed of different materials. Specifically, the current collector 5 connected to the positive electrode 10 is formed of, for example, aluminum or aluminum alloy, and the current collector 5 connected to the negative electrode 20 is formed of, for example, copper or copper alloy.

The energy storage device 1 of this embodiment includes an insulating member 8 for insulating the electrode assembly 2 and the case 40. For example, the insulating member 8 is disposed between the case 40 (more specifically, the case body 45) and the electrode assembly 2. The insulating member 8 is formed of, for example, sheet-like member having insulating properties. The insulating member 8 is formed of, for example, a resin such as polypropylene or polyphenylene sulfide.

A method of manufacturing the nonaqueous electrolyte secondary battery 1 (lithium ion secondary battery) as the above energy storage device 1 will be described below.

The nonaqueous electrolyte secondary battery 1 is manufactured by a general method.

For example, the nonaqueous electrolyte secondary battery 1 can be manufactured by performing: a wide electrode plate producing step of producing a wide electrode plate including a sheet-like pre-cutting current collecting substrate and pre-cutting active material layers disposed on both sides of the pre-cutting current collecting substrate; a cutting step of producing the positive electrode 10 and the negative electrode 20 as an electrode by cutting the wide electrode plate in the thickness direction; an electrode assembly producing step of producing the electrode assembly 2 by layering the positive electrode 10 and the negative electrode 20, which are produced by the cutting, and the separator 3 in the thickness direction; and an accommodating step of accommodating the electrode assembly 2 and the electrolyte solution in the case 40.

In the wide electrode plate producing step, a wide positive electrode plate (original positive electrode) and a wide negative electrode plate are respectively produced as the wide electrode plate.

In the production of the wide positive electrode plate, for example, a positive composite is prepared by mixing of the above-described particulate positive active material, the conductive agent, the binder, and the thickener with an organic solvent such as N-methyl-2-pyrrolidone (NMP). Thereafter, the positive composite is applied onto both sides of the sheet-like pre-cutting positive electrode current collecting substrate. Then, the organic solvent is volatilized from the positive composite by drying, and thus the wide positive electrode plate is produced in which the positive active material layer 12 is disposed on both sides of the pre-cutting positive electrode current collecting substrate.

As the pre-cutting positive electrode current collecting substrate, the same material as the above-described positive electrode current collecting substrate 11 is employed.

In the production of the wide positive electrode plate, as a method of mixing the positive active material, the conductive agent, the binder, the thickener, and the like, a method of mixing the above materials using, for example, a powder mixer such as a V-type mixer, an S-type mixer, a stone mill, a ball-milling, or a planet ball-milling.

In the production of the wide positive electrode plate, a method of applying the positive composite onto the wide positive electrode current collecting substrate plate is not particularly limited, but employs, for example, roller coating such as an applicator roll, screen coating, blade coating, spin coating, or bar coating.

For example, the wide negative electrode plate is produced in the same manner as in the wide positive electrode plate.

Specifically, the wide negative electrode plate is produced by the same method as, for example, the method of producing the wide positive electrode plate described above except for using the particulate negative active material instead of the particulate positive active material.

That is, in the production of the wide negative electrode plate, for example, after a negative composite is prepared by mixing of the above-described particulate positive active material, the binder, and the thickener with an organic solvent, the negative composite is applied onto both sides of the sheet-like pre-cutting negative electrode current collecting substrate. Subsequently, the organic solvent is volatilized from the negative composite by drying. Then, the wide negative electrode plate is produced in which the negative electrode active material layers are disposed on both sides of the pre-cutting negative electrode current collecting substrate.

As the pre-cutting negative electrode current collecting substrate, the same material as the above-described negative electrode current collecting substrate 21 is employed.

In the cutting step, the wide positive electrode plate and the wide negative electrode plate are cut by a general method.

As the cutting method, for example, a method of cutting the wide plate using the Thomson blade attached to the Thomson punching machine can be employed. Furthermore, for the cutting, a gang mode, a shear mode, a laser type, or a score type can be employed.

As described above, the bent end portion 6 is formed on the electrode by the cutting in the cutting step. In the cutting, the cutting force is applied to either of the wide positive electrode plate and the wide negative electrode plate toward one direction at least in the thickness direction. Accordingly, by the cutting in the cutting step, as the density of the active material layer disposed on one surface of the current collecting substrate becomes higher, the density of the active material layer disposed on the other surface of the current collecting substrate becomes lower at the bent end portion 6. In addition, the current collecting substrate is bent toward the active material layer having the high density.

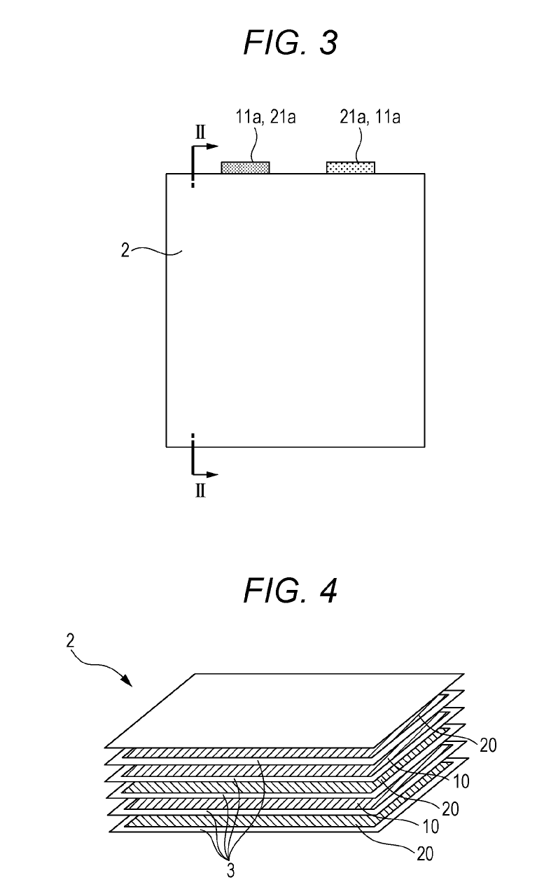

In the electrode assembly producing step, for example, the plate-shaped electrode assembly 2 is produced as illustrated in FIGS. 3 to 5.

For example, the electrode assembly 2 is produced in such a manner that the sheet-like positive electrode 10, the sheet-like separator 3, the sheet-like negative electrode 20, and the sheet-like separator 3 are layered in the thickness direction in this order, respectively. At this time, the positive electrode 10 and the negative electrode 20 are layered such that the bent end portion 6 of the positive electrode 10 and the bent end portion 6 of the negative electrode 20 are at least adjacent to each other and that the direction of the positive electrode current collecting substrate 11 and the direction of the negative electrode current collecting substrate 21 are opposite to each other, at the bent end portions 6 adjacent to each other. In addition, the plurality of positive electrodes 10 are arranged in the layered direction such that the current collecting substrates at the bent end portions of the positive electrodes 10 have the same bending direction, and the plurality of negative electrodes 20 are arranged in the layered direction such that the current collecting substrates at the bent end portions of the negative electrodes 20 have the same bending direction. Further, the positive electrode 10, the separator 3, and the negative electrode 20 can be layered in the same manner. When the electrode assembly 2 is formed by layering the plurality of positive electrodes 10 and the plurality of negative electrodes 20 one by one, for example, the positive electrodes 10 are electrically connected to the negative electrodes 20 in parallel, respectively.

In addition, for example, the winding-type electrode assembly 2 illustrated in FIG. 7 can be produced in the electrode assembly producing step.

In the production of the winding-type electrode assembly 2, for example, a layered body is produced in such a manner that the band-like positive electrode 10, the band-like separator 3, the band-like negative electrode 20, and the band-like separator 3 are layered in the thickness direction in this order, respectively. At this time, the positive electrode 10 and the negative electrode 20 are layered such that the bent end portion 6 of the positive electrode 10 and the bent end portion 6 of the negative electrode 20 are at least adjacent to each other and that the bending directions of the current collecting substrates are opposite to each other at the bent end portions 6, respectively. The layered body is wound around an axis as a winding axis extending in the width direction of the layered body. In this way, the winding-type electrode assembly 2 is produced.

In the accommodating step, the produced electrode assembly 2 and the electrolyte solution are accommodated in the case 40. In addition, the flat terminal 51 is connected to the electrode assembly 2 by the welding of the outer portion of the current collecting tab 11a of each of the electrodes and the flat terminal 51.

Specifically, the electrode assembly 2 is disposed in the case 40 by joining the flange portions 41b of the case pieces 41 described above. At this time, the pre-prepared electrolyte solution is accommodated in the case 40. At this time, the flat terminal 51 for the positive electrode is connected to the current collecting tab 11a of the bundled positive electrode 10 and the flat terminal 51 for the negative electrode is connected to the current collecting tab 21a of the bundled negative electrode 20. In addition, at this time, a part of the flat terminal 51 for the positive electrode and a part of the flat terminal 51 for the negative electrode are disposed outside the case 40, respectively.

Meanwhile, in the case of the production of the winding-type electrode assembly 2, for example, first, the positive electrode 10, the separator 3, the negative electrode 20, and the separator 3 are overlapped with one another in this order and are then wound, thereby forming the electrode assembly 2 in the accommodating step. Next, the electrode assembly 2 is accommodated in the case body 45. Thereafter, the current collector 5 is connected to each of the positive electrode 10 and the negative electrode 20. Furthermore, the current collector 5 and the external terminal 55 are connected to each other while the case body 45 is covered with the cover plate 46 mounted with the external terminal 55. In this state, the case body 45 and the cover plate 46 are welded. The electrolyte solution is injected through a liquid injection port. Finally, the liquid injection port is blocked with the liquid injection plug 46b.

Thus, it is possible to manufacture the nonaqueous electrolyte secondary battery 1 as the energy storage device.

The energy storage device of the present invention is not limited to the above embodiment, and various changes and modifications may be naturally made without departing from the scope and sprit of the present invention. For example, a configuration of another embodiment can be added to a configuration of an embodiment or a part of the configuration of an embodiment can be replaced by the configuration of another embodiment. Moreover, a part of the configuration of an embodiment can be removed.

Further, the above embodiment describes the case where the energy storage device is used as the chargeable/dischargeable nonaqueous electrolyte secondary battery (for example, lithium ion secondary battery), but the type and size (capacity) of the energy storage device are arbitrary. In addition, the above embodiment describes the lithium ion secondary battery as an example of the energy storage device, but is not limited thereto. For example, the invention is applicable to primary batteries or energy storage devices of capacitor such as an electric double layer capacitor in addition to various secondary batteries.

The energy storage device (for example, battery) of the above embodiments may be used in an energy storage apparatus (battery module when the energy storage device is a battery). The energy storage apparatus includes at least two energy storage devices 1 and a bus-bar member used to electrically connect two (different) energy storage devices 1 to each other. In this case, at least one of the above energy storage devices 1 may be applied to the energy storage device 1.

What is claimed is:

1. An energy storage device comprising:
a sheet-like positive electrode and a sheet-like negative electrode, the positive electrode and the negative electrode being layered;
wherein each of the electrodes includes a current collecting substrate and active material layers disposed on both surfaces of the current collecting substrate,
at least a part of each of the current collecting substrates extends to an end portion of each of the electrodes and is bent toward one side in a layered direction at the end portion, and
a bending direction of the current collecting substrate in the layered direction at the end portion of the positive electrode is opposite to a bending direction of the current collecting substrate in the layered direction at the end portion of the negative electrode which is adjacent to the end portion of the positive electrode.

2. The energy storage device according to claim 1, wherein the end portions of the positive electrode and the negative electrode are alternately arranged in the layered direction,
the end portions of the current collecting substrate of the positive electrode are bent in the same direction in the layered direction, and
the end portions of the current collecting substrate of the negative electrode are bent in an opposite direction to the end portions of the current collecting substrate of the positive electrode in the layered direction.

3. The energy storage device according to claim 1, wherein a thickness of the positive electrode and a thickness of the negative electrode are constant.

4. The energy storage device according to claim 1, wherein at least one of the positive electrode and the negative electrode is formed in a rectangular shape and the bending directions of the current collecting substrate are the same at the end portions along at least two sides of the one rectangular electrode.

5. The energy storage device according to claim 2, wherein a thickness of the positive electrode and a thickness of the negative electrode are constant.

6. The energy storage device according to claim 2, wherein at least one of the positive electrode and the negative electrode is formed in a rectangular shape and the bending directions of the current collecting substrate are the same at the end portions along at least two sides of the one rectangular electrode.

7. The energy storage device according to claim 3, wherein at least one of the positive electrode and the negative electrode is formed in a rectangular shape and the bending directions of the current collecting substrate are the same at the end portions along at least two sides of the one rectangular electrode.

8. The energy storage device according to claim 5, wherein at least one of the positive electrode and the negative electrode is formed in a rectangular shape and the bending directions of the current collecting substrate are the same at the end portions along at least two sides of the one rectangular electrode.
